(19) United States
(12) Patent Application Publication
(10) Pub. No.: US 2015/0056435 A1
(43) Pub. Date: Feb. 26, 2015

(54) TRANSPARENT CONDUCTING ELECTRODES COMPRISING MESOSCALE METAL WIRES

(71) Applicant: The Board of Trustees of the Leland Stanford Junior University, Palo Alto, CA (US)

(72) Inventors: Po Chun Hsu, Palo Alto, CA (US); Shuang Wang, Palo Alto, CA (US); Hui Wu, Mountain View, CA (US); Yi Cui, Stanford, CA (US)

(21) Appl. No.: 14/469,104

(22) Filed: Aug. 26, 2014

Related U.S. Application Data
(60) Provisional application No. 61/869,977, filed on Aug. 26, 2013.

(51) Int. Cl. H01B 1/02; H01B 1/12; D01D 5/00; H01B 1/04

(52) U.S. Cl. CPC H01B 1/02; H01B 1/04; H01B 1/124; D01D 5/0007; D10B 2321/00; D10B 2401/18; D10B 2401/20
USPC 428/298.1; 252/512; 252/503; 264/10; 428/297.4

(57) ABSTRACT

A composition suitable for use in a transparent conducting electrode (TCE) is disclosed. The composition comprises a conductive background medium and an incorporated plurality of mesoscale metal wires. The composition is characterized by lower electrical sheet resistance as compared to prior-art compositions for TCEs without a significant degradation in optical transmittance.

### CROSS REFERENCE TO RELATED APPLICATIONS

This application claims the benefit of U.S. Provisional Application Ser. No. 61/869977, filed Aug. 26, 2013, entitled “Transparent Conducting Electrodes Comprising Mesoscale Metal Wires,” (Attorney Docket 146-046PR1), which is incorporated by reference. If there are any contradictions or inconsistencies in language between this application and one or more of the cases that have been incorporated by reference that might affect the interpretation of the claims in this case, the claims in this case should be interpreted to be consistent with the language in this case.

### STATEMENT REGARDING FEDERALLY SPONSORED RESEARCH

This invention was made with Government support under DE-SC0001060 awarded by the department of Energy. The Government has certain rights in the invention.

### FIELD OF THE INVENTION

The present invention relates to electronic devices in general, and, more particularly, to optoelectronic devices.

### BACKGROUND OF THE INVENTION

A transparent conducting electrode (TCE) is an electrically conductive device that is also substantially transparent for light (typically visible light). TCEs are commonly used in many consumer optoelectronic devices, such as video displays, smart-phone screens, smart windows, etc. They are also important elements of optoelectronic devices, such as solar cells, organic light-emitting diodes, anti-static coatings, electromagnetic shielding, among others.

A TCE ideally comprises a material that simultaneously has low electrical sheet resistance (R_{S}) and high optical transmittance (T). Historically, the most common TCEs are based on conductive oxides, such as indium tin oxide (ITO), fluorine-doped tin oxide (FTO), aluminum-doped zinc oxide (AZO), or zinc oxide (ZnO). These materials are used to provide an electrode structure that is a substantially continuous film (often referred to as a “Type-1 TCE”). For years, the de-facto industry standard TCE material has been ITO, which has an Rs value of approximately 5 to 20 Ω/square (Ω/□) at a transmittance of approximately 90%.

Other prior-art materials that have found use in substantially continuous-film TCEs include large-area graphene and conducting polymers. TCEs based on these materials have been demonstrated with high transmittance (>90%) and sheet resistances within the ranges of 30 to 1000 Ω/□ and 100 to 450 Ω/□, respectively.

More recently, new TCE materials have been developed in an effort to reduce cost and/or increase mechanical flexibility. Much of this development has been directed toward materials based on networks of one-dimensional nanomaterials (referred to as “Type-2 TCEs”), such as carbon nanotubes (CNTs), graphene nanoribbons, metal nanowires, and nanowires of oxides and other compounds. Many of these materials have shown great promise. For example, TCEs having T>90% and low sheet resistance have been demonstrated for TCEs based on metal nanowires (R_{S} within the range of 10 to 30 Ω/□), CNTs (R_{S} within the range of 60 to 400 Ω/□), TiN nanofibers (R_{S} within the range of 100 to 200 Ω/□), and oxide nanowires (Rs within the range of 2000 to 10000 Ω/□). While having a resistivity that is higher than that of ITO, these materials offer the potential for significantly reduced cost and, as a result, are still viewed as attractive alternatives to conductive oxides.

Metal nanowire TCEs, in particular, offer great promise for excellent performance due to the inherent high conductivity of metals. Various methods have been proposed to improve metal-nanowire TCE performance. For example, it is expected that transmittance can be increased by reducing light scattering, which can be effected by increasing nanowire length and/or reducing wire diameter. Unfortunately, each of these changes tends to decrease the distance over which electrons can be transported by the nanowire without incurring high ohmic loss.

Alternatively, electrical resistance can be reduced by annealing nanowire junctions via thermochemical, electrochemical, and/or nano-plasmonic welding to reduce electrical resistance at these junctions. This technique has, indeed, improved the performance of nanowire-based TCEs to the point where TCEs with R_{S} of approximately 10 Ω/□ at T=90% have been demonstrated.

Even with the progress in the development of metal-nanowire-based TCEs, however, there remains a need for TCEs having ever better R_{S}-T performance to enable dramatically improved performance for many optoelectronic devices.

### SUMMARY OF THE INVENTION

The present invention enables a TCE having lower electrical sheet resistance than TCEs of the prior art while maintaining good optical transmittance. TCEs in accordance with the present invention include mesoscale wires that are incorporated into a TCE background medium, such as nanowires, conducting polymers or oxides, etc., such that the mesoscale wires reduce the sheet resistance of the medium without significantly reducing overall optical transparency. Embodiments of the present invention are particularly well suited for use in optoelectronic devices, such as solar cells, touch screens, displays, and the like.

An illustrative embodiment of the present invention is a TCE comprising a hierarchical arrangement of wires types, wherein each wire type has a different width and a length suitable for transporting electrons with low ohmic loss, and wherein the wires of each wire type are arranged with a wire-diameter-based, inter-wire spacing suitable for providing transparency at the operating wavelengths of light for the TCE. Specifically, the illustrative embodiment includes a wire network that includes short nanowires suitable for transporting electrons over short distances, longer macroscale wires suitable for transporting electrons over long distances, and medium-length mesoscale metal wires that provide a “bridge” for transporting electrons between the nanowires and macroscale wires. The spacing between elements of each wire type (i.e., the inter-wire spacing) is based on the width of that wire type and the wavelengths of light for which the TCE must be transparent, such that the individual arrangements of each wire type have high optical transmittance, thereby enabling high optical transmittance for the composite wire structure.

In the illustrative embodiment, the higher conductance of the mesoscale wires enables transport of electrons across several millimeters of distance, which enables a reduction in the distance the low-conductance nanowires must transport electrons to only several hundreds of microns.

In some embodiments of the present invention, mesoscale wires are incorporated into other types of transparent electrodes.

In some embodiments, the mesoscale wires are formed by depositing a metal, such as copper, onto polymer fibers that have been formed via electro-spinning.

An embodiment of the present invention is a TCE composition comprising: a background medium that includes a first material that is electrically conductive; and a plurality of mesoscale wires, each mesoscale wire of the plurality thereof comprising a second material that is electrically conductive; wherein the background medium and the plurality of mesoscale wires are electrically connected, and wherein the TCE composition has a sheet resistance that is less than or equal to 1 ohm/square and a transmittance for an optical signal that is equal to or greater than 75%.

### BRIEF DESCRIPTION OF THE DRAWINGS

FIG. 1 depicts a schematic drawing of a TCE in accordance with an illustrative embodiment of the present invention.

FIG. 2A depicts simulated sheet-resistance and transmittance data as a function of wire width, a, and inter-wire spacing, s, for different width-scale arrays of metal wires having uniform widths.

FIG. 2B depicts simulated sheet-resistance and transmittance data for transparent conducting electrodes in accordance with the present invention.

FIG. 3 depicts operations of a method for forming a TCE in accordance with the illustrative embodiment of the present invention.

FIG. 4 depicts a photo of a portion of a transparent conductive electrode in accordance with the illustrative embodiment of the present invention.

FIG. 5 depicts sheet-resistance and transmittance data for transparent conducting electrodes in accordance with the illustrative embodiment as a function of inter-wire spacing.

FIG. 6 depicts operations of a method suitable for forming a nanowire and mesoscale wire network in accordance with a first alternative embodiment of the present invention.

FIG. 7 depicts a pictorial representation of process 600.

FIG. 8A depicts a scanning electron microscope picture of a portion of a transparent conductive electrode in accordance with the first alternative embodiment of the present invention.

FIG. 8B depicts a scanning electron microscope picture of a fused junction between a nanowire 802 and a mesoscale wire 804.

FIG. 9 depicts measured performance results for copper mesoscale wires transferred onto different material networks.

FIG. 10A depicts the coloration response versus time for PEDOT:PSS-based electrochromic devices, with and without, incorporated mesoscale wires.

FIG. 10B provides Table 1, which includes measured bleaching and coloring response times for TCE_Composition1 and TCE_Composition2.

FIG. 10C depicts a photograph of a TCE comprising copper mesoscale wires in its color state and bleached state.

### DETAILED DESCRIPTION

The following terms are defined for use in this Specification, including the appended claims:
“nanowire” is defined as a wire having a width within the range of approximately 1 nanometer (nm) to approximately 300 nm. One skilled in the art will recognize that the term “width” refers to one dimension of a wire, typically its smaller dimension within a plane parallel to the plane of the substrate on which it is formed, and that for a substantially circular wire, “width” refers to the diameter of the wire.
“macroscale wire” is defined as a wire having a width that is of order tens of microns and typically about 50 microns.
“mesoscale wire” is defined as a wire having a width between the range of widths of nanowires and the range of widths of macroscale wires. Typically, mesoscale wires have widths within the range of approximately 1 micron to approximately 10 microns.

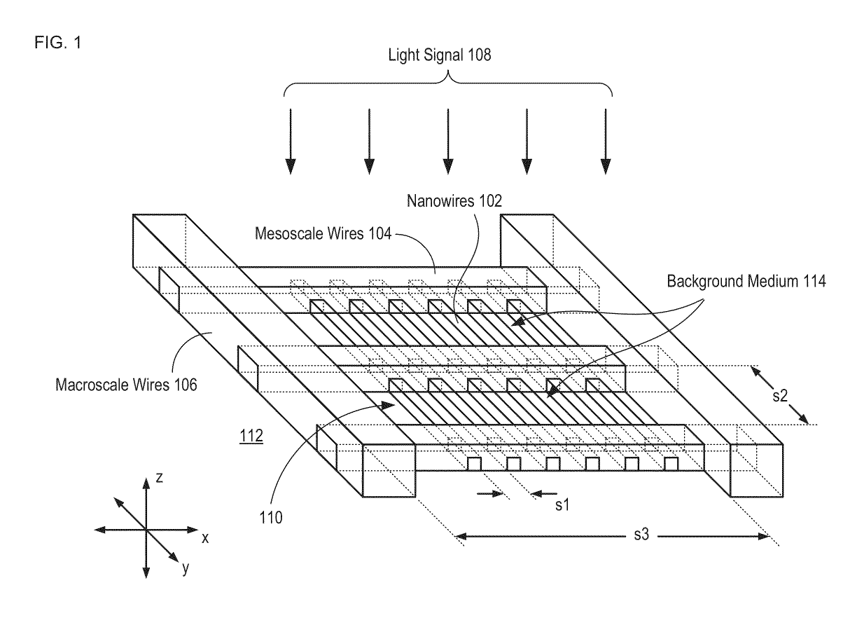

FIG. 1 depicts a schematic drawing of a TCE in accordance with an illustrative embodiment of the present invention. TCE 100 includes nanowires 102, macroscale wires 106, and mesoscale wires 104. Nanowires 102, macroscale wires 106, and mesoscale wires 104 are arranged in a hierarchical network such that nanowires 102 function to locally collect and/or distribute electrons, macroscale wires 106 connect TCE 100 with other electronic circuits, and mesoscale wires 104 provide highly conductive transport pathways (i.e., bridges) between the nanowires and the macroscale wires. In such arrangements, each wire type is used to provide electrical conductivity over a length suitable for its width (i.e., its dimension in the x-direction, as shown). Further, the wires within the arrangements of each wire-type are spaced to avoid significantly degrading the transmittance of TCE 100 for the wavelengths in light signal 108. The width and inter-wire spacing for each wire-type arrangement are inter-related dimensions that are based on the wavelengths of light included in light signal 108, as discussed below.

It should be noted that FIG. 1 depicts only one possible arrangement of nanowires, macroscale wires, and mesoscale wires and it will be clear to one skilled in the art, after reading this Specification, how to specify, make, and use alternative embodiments comprising arrangements that comprise any practical number, length, and inter-wire spacing of each of the macroscale wires, mesoscale wires, and nanoscale wires.

The present invention enables improved TCE performance, as compared by to the prior art, by incorporating mesoscale wires into a TCE background medium. Advantages afforded embodiments of the present invention are readily perceived by comparing TCE compositions with, and without, the inclusion of mesoscale wires, as follows.

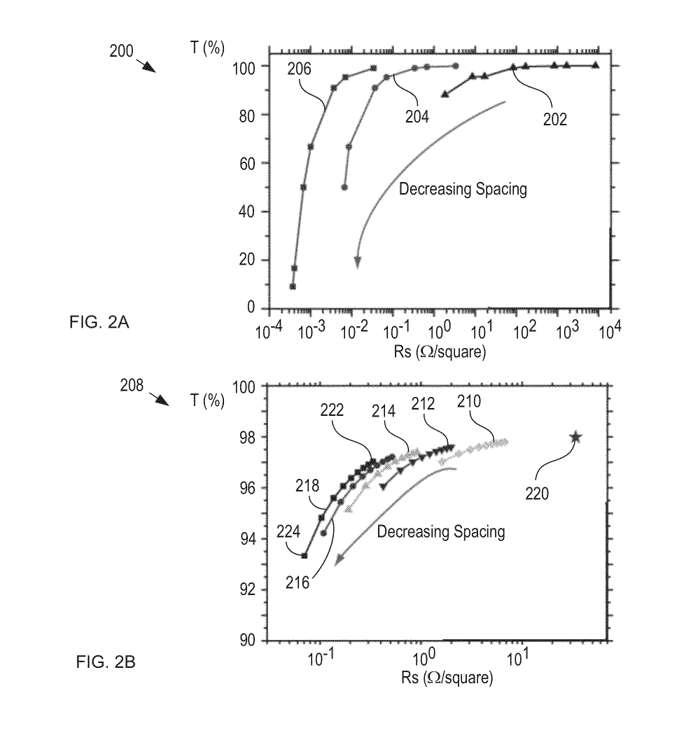

FIG. 2A depicts simulated sheet-resistance and transmittance data as a function of wire width, a, and inter-wire spacing, s, for different width-scale arrays of metal wires having uniform widths. Plot 200 includes R_{S}-T curves for TCE compositions having parallel wire arrays of different width scales, where the simulation is based on wires having a square cross-section (for simplicity). Sheet resistance is estimated according to:

R_{S}=ρ(s+a)/² ,(1)

where ρ=16.8Ω·nm.

Trace 202 shows the R_{S}-T trend for nanowires having a wire width of 100 nm, with data points at inter-wire spacings of 1, 5, 10, 50, 100, 500, 1000, and 5000 microns. Transmittance for the nanowire arrays is simulated using rigorous coupled-wave analysis (RCWA), where the transmittance spectra (400-1100 nm) are weighted for the AM1.5 solar spectrum to derive the average transmittance, TAM 1.5.

Trace 204 shows the R_{S}-T trend for mesoscale wires having a wire width of 5 microns with data points at inter-wire spacings of 5, 10, 50, 100, 500, 1000, and 5000 microns.

Trace 206 shows the R_{S}-T trend for macroscale wires having a wire width of 50 microns with data points at inter-wire spacings of 5, 10, 50, 100, 500, 1000, and 5000 microns.

Transmittance for each of the mesoscale- and macroscale-wire arrays is simulated using geometrical shadow loss, where:

T=S/(S+a)×100%. (2)

Several inferences can be made based on plot 200, including:
i. when the spacing between wires is large enough, arrays of each of the three scales of wires can exhibit high transmittance (i.e., T>95%);
ii. at high transmittance, the sheet resistance of each of the three wire types falls in different regimes—10⁻³ to 10⁻¹ Ω/□ for macroscale wires, 0.01 to 10 Ω/58 for mesoscale wires, and 10 to 100 Ω/□ for nanowires; and
iii. macroscale wires appear to be better for individual use in a TCE than either of the mesoscale wires and nanowires, since R_{S} has quadratic dependence on wire diameter (according to Eq. 1, above) but T has only linear dependence in the regime of diameter and inter-wire spacing much larger than wavelength of the light (according to Eq. 2, above).

It should be noted, however, that the inter-wire spacings at which macroscale wires achieve high-transmittance give rise to high sheet resistance and, therefore, will result in large ohmic losses during TCE operation. As a result, it is preferable that transportation of electrons to/from local areas in an optoelectronics device is done via small diameter wires (e.g., nanowires). On the other hand, it can be seen from traces 202 through 206 that an array containing only nanoscale wires exhibits inferior R_{S}-T performance and would not be efficient enough to transport electrons to or from macroscale wires.

The present invention overcomes the above conflict by incorporating mesoscale wires into a TCE background medium to act as a bridge between the nanoscale wires and macroscale wires.

FIG. 2B depicts simulated sheet-resistance and transmittance data for transparent conducting electrodes in accordance with the present invention. Plot 208 includes R_{S}-T curves for TCE compositions having different configurations of mesoscale wires incorporated into the same background medium. In each case, the background medium is a parallel arrangement of nanowires having a width of 50 nm and an inter-wire spacing of 5 microns.

Traces 210 through 218 correspond to TCE compositions that include parallel mesoscale wires having widths of 1, 2, 3, 4, and 5 microns, respectively. The data points in each trace correspond to inter-wire spacings within the range of 100 microns to 500 microns. Data point 220 indicates the calculated sheet resistance (34 Ω/□) and transmittance (T˜98%) for the background medium alone (i.e., the arrangement of nanowires without the inclusion of any mesoscale wires).

It is readily seen from a comparison of plots 200 and 208 that combining mesoscale wires with nanoscale wires significantly improves the performance of metal-wire-based TCEs. Data point 222 of trace 218, for example, indicates that a TCE composition comprising mesoscale wires having a width of 5 microns and an inter-wire spacing of 500 microns is characterized by a sheet resistance of sheet resistance of 0.34 Ω/□ and a transmittance of 97%. Likewise, data point 224 of trace 218 indicates that a TCE composition comprising mesoscale wires having a width of 5 microns is characterized by a sheet resistance of sheet resistance of 0.07 Ω/□ and a transmittance of 93%. In other words, the inclusion of 5-micron diameter mesoscale wires in a background medium of nanowires make a TCE composition 100-1000 times more conducting at the cost of only a slight drop in transmittance.

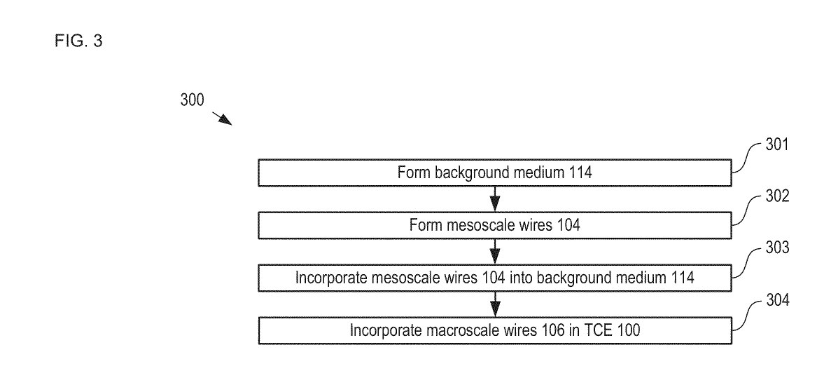

FIG. 3 depicts operations of a method for forming a TCE in accordance with the illustrative embodiment of the present invention. Method 300 begins with operation 301, wherein background medium 114 is formed. Method 300 is described with continuing reference to FIG. 1.

Background medium 114 comprises a plurality of nanowires that are arranged in substantially parallel fashion. For the purposes of this Specification, including the appended claims, “substantially parallel” is defined as parallel within five degrees of parallelism. One skilled in the art will recognize that nearly perfect parallelism of photolithographically defined elements is easily achieved. In some embodiments of the present invention, however, background medium 114 includes elements formed other than photolithographically. In such embodiments, perfect parallelism is more difficult to achieve and more “generally parallel” arrangement typically results.

Nanowires 102 are gold wires having width (or diameter) within the range of approximately 1 nm to approximately 300 nm and, preferably, less than or equal to 100 nm. In TCE 100, nanowires have a width of approximately 270 nm and height of approximately 120 nm.

Nanowires 102 are formed on substrate 112 via e-beam lithography and conventional metal deposition and lift-off processing. In some embodiments, nanowires 102 are formed using another suitable conventional process, such as nanoimprinting and metal evaporation, polymer electro-spinning and metal evaporation, subtractive patterning via etching, etc.

Substrate 112 is a conventional substrate suitable for use in planar processing fabrication. Materials suitable for use in substrate 112 include, without limitation, quartz, silicon and silicon compounds, compound semiconductors, ceramics, composite materials, and the like.

Nanowires 102 are arranged in rows 110 such that, within each row, they form an array of parallel nanowires having an inter-wire spacing, s1, within the range of approximately 3 microns to 30 microns. Inter-wire spacing within this range mitigates scatter of light signal 108 by the nanowires, thereby facilitating high transmittance. In TCE 100, nanowires 102 have an exemplary inter-wire spacing of approximately 5 microns.

It should be noted that the number of rows 110, the number of nanowires per row, the width of nanowires 102, and the inter-wire spacing, s1, are all matters of design choice and can have any suitable values.

At operation 302, mesoscale wires 104 are formed. Mesoscale wires 104 are formed via conventional photolithography, metal deposition, and lift-off processing. After their formation, mesoscale wires 104 are physically and electrically connected with nanowires 102.

Mesoscale wires 104 are formed such that they are copper wires having a width within the range of approximately 1 micron to approximately 5 microns, where the height is preferably larger than the width. In the illustrative embodiment, mesoscale wires 104 have an exemplary width of approximately 5 microns and an exemplary height of approximately 2.8 microns.

Mesoscale wires 104 have an inter-wire spacing, s2, within the range of approximately 50 microns to approximately 500 microns. In the illustrative embodiment, mesoscale wires 104 have an inter-wire spacing of approximately 400 microns. In some embodiments, mesoscale wires 104 are arranged to mitigate shadowing effects.

At operation 303, mesoscale wires 104 are incorporated into background medium 114, thereby forming a joint composition in which the mesoscale wires and the background medium are electrically connected. In the illustrative embodiment, incorporation of mesoscale wires 104 occurs inherently during their fabrication. In some embodiments, additional processing, such as annealing, applying pressure (e.g., via a roll pressing operation, etc.), and the like, is included to facilitate the incorporation of mesoscale wires 104 into background medium 114.

At operation 304, macroscale wires 106 are incorporated into TCE 100. Macroscale wires 106 are formed on substrate 112 via conventional photolithography and metal deposition. After their formation, macroscale wires 106 are physically and electrically connected with mesoscale wires 104.

Each of macroscale wires 106 is a gold wire having a width that is of order tens of microns and typically about 50 microns. Macroscale wires 106 have an inter-wire spacing, s3, which is within the range of approximately 1 millimeter (mm) to approximately 5 mm. In the illustrative embodiment, macroscale wires 106 have an exemplary width of approximately 100 microns, an exemplary height of approximately 400 microns, and an exemplary inter-wire spacing of approximately 3 mm.

Nanowires 102, macroscale wires 106, and mesoscale wires 104 are incorporated and arranged such that mesoscale wires 104 provide interconnection between nanowires 102 and macroscale wires 106, thereby enabling the electrons collected and/or distributed by nanowires 102 to easily transit to and from external electronics with low ohmic loss. Preferably, mesoscale wires 104 have high electrical conductance and, therefore, large cross-sectional area; however, they should not significantly impede light transmission. As a result, in some embodiments, mesoscale wires are formed such that each has a cross-section that is defined by a height that is larger than its width (i.e., its dimensions in the z- and x-directions, respectively, as indicated in FIG. 1). This enables large cross-sectional area structures that, collectively, have low fill-factor along the x-direction.

Although in the illustrative embodiment, mesoscale wires 104 comprise copper and each of nanowires 102 and macroscale wires 106 comprises gold, it will be clear to one skilled in the art, after reading this Specification, how to specify, make, and use alternative embodiments wherein nanowires 102, macroscale wires 106, and mesoscale wires 104 comprise any suitable highly electrically conductive material. Materials suitable for use in any of nanowires 102, macroscale wires 106, and mesoscale wires 104 include, without limitation, metals (e.g., gold, copper, silver, aluminum, tungsten, zinc, nickel, etc.), and the like. In some embodiments, mesoscale wires 104 have a cross-sectional shape other than rectangular, such as circular, elliptical, square, or irregular.

It is an aspect of the present invention that the combination of mesoscale wires with nanowires and macroscopic wires enables the promotion of electron conduction over multiple length scales with minimum power loss. For example, in TCE 100, the nanowire network no longer needs to transport electrons to a several mm-long distance as in the prior-art combination of only nanowires and macroscopic metal wires. In contrast, in embodiments of the present invention, nanowires 102 need only transport electrons for several hundreds of microns because the transport of electrons across several millimeters of distance is carried out by mesoscale wires having much higher conductance.

It should be noted that an orthogonal configuration of nanowires, mesoscale wires, and macro scale wires is preferred because such an arrangement gives rise to the shortest transport path for electrons. One skilled in the art will recognize, however, after reading this Specification, that nanowires, mesoscale wires, and macro scale wires can be arranged in non-regular arrangements without departing from the scope of the present invention. In such embodiments, s1, s2, and s3 represent the average (or typical) wire spacing for their respective wire type.

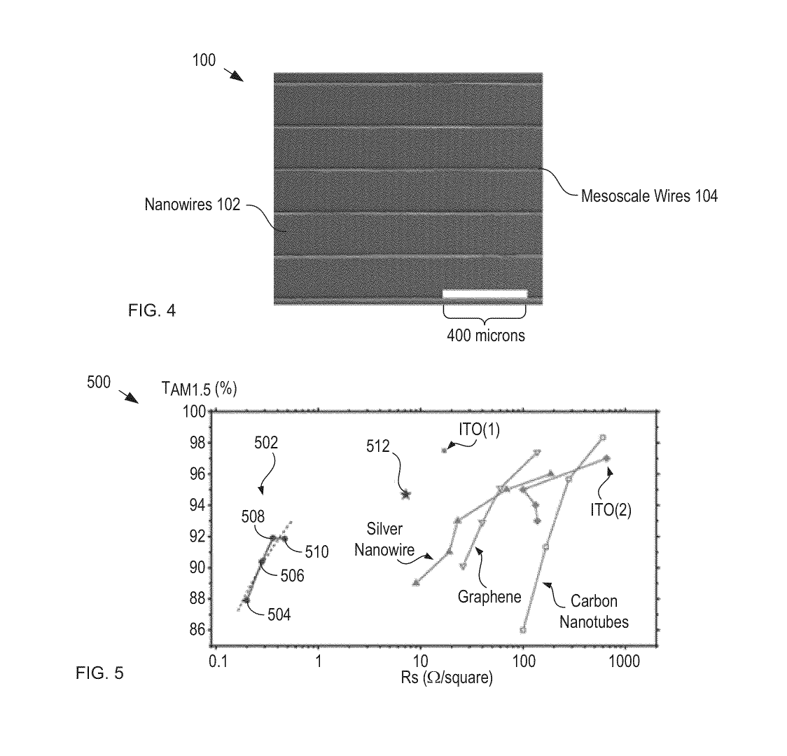

FIG. 4 depicts a photo of a portion of a transparent conductive electrode in accordance with the illustrative embodiment of the present invention.

FIG. 5 depicts sheet-resistance and transmittance data for transparent conducting electrodes in accordance with the illustrative embodiment as a function of inter-wire spacing. Plot 400 includes R_{S}-T curves for TCEs analogous to TCE 100, where mesoscale wires 104 with different inter-wire spacings. In each case, nanowires 102 are formed as having a width of 50 nm and an inter-wire spacing of 5 microns.

Trace 502 includes data points 504 through 510, which correspond to TCE compositions having an inter-wire spacing for mesoscale wires 104 of 200, 300, 400, and 500 microns, respectively.

Data point 512 represents the R_{S}-T performance of the array of nanowires 102, alone, which was determined to be R_{S}=7.2 Ω/□ and T=95%, consistent with optical simulation.

Trace 502 demonstrates that 0.36 Ω/□ at T=92% can be achieved. This represents an order of magnitude improvement in R_{S} over the prior art with little change in T. As a result, the present invention enables TCEs having performance that greatly exceeds the traditional limit of single-layer transparent electrodes.

It is another aspect of the present invention that increasing the thickness of mesoscale wires 104 does not significantly degrade the transmittance of TCE 100. For some highly conducting mesoscale wires, therefore, it is advantageous for the thickness of the mesoscale wires to be comparable to their width, thereby reducing the sheet resistance of the TCE without sacrificing transmittance.

For comparison, plot 500 includes the performance of several prior-art transparent electrodes, including silver nanowires (AgNWs), ITO compositions, graphene, and carbon nanotubes (CNTs).

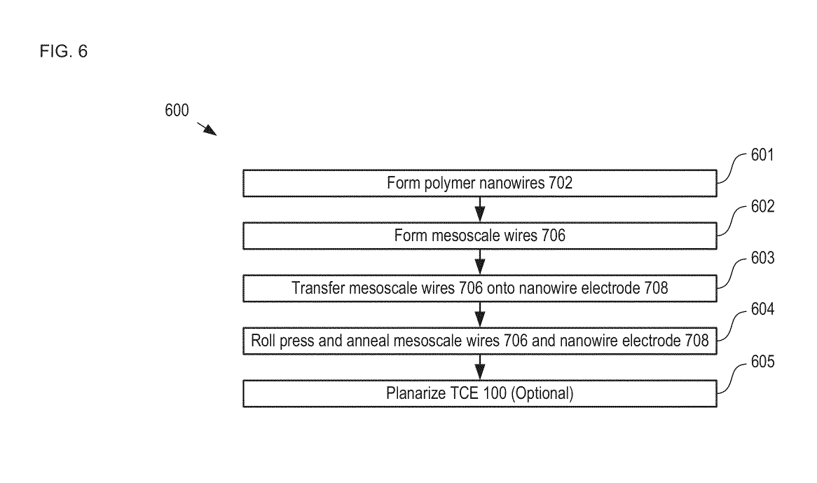

FIG. 6 depicts operations of a method suitable for forming a nanowire and mesoscale wire network in accordance with a first alternative embodiment of the present invention. Process 600 provides a more facile, lithography-free fabrication of a mesoscale metal network design in accordance with the present invention. Further, process 600 enables the production of ultra-long copper mesoscale wires (CuMWs) with ˜1 micron diameter. It will be clear to one skilled in the art, after reading this Specification, that process 600 represents only one example of a process suitable for forming embodiments of the present invention. Process 600 begins with operation 601, wherein polymer nanowires are formed via electro-spinning.

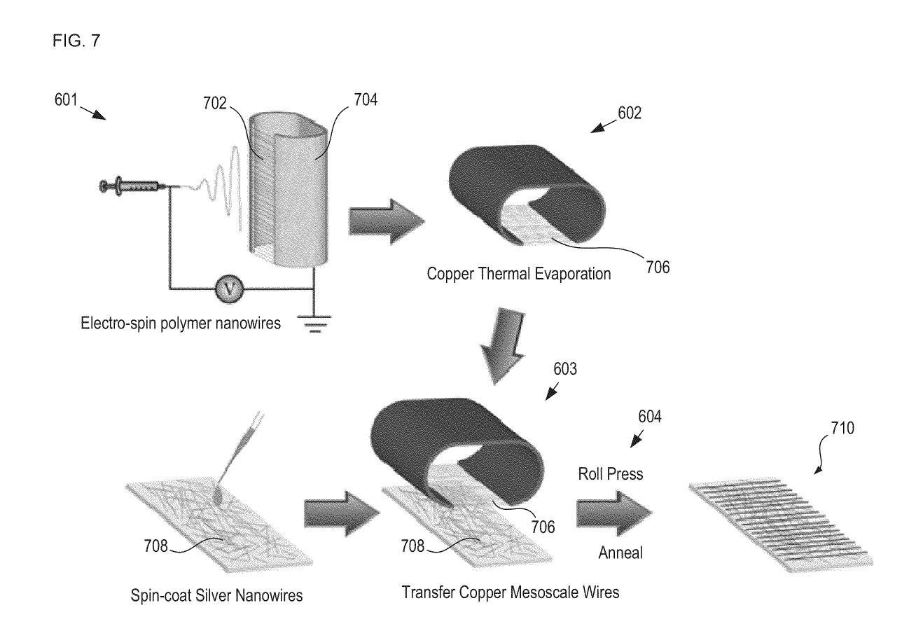

FIG. 7 depicts a pictorial representation of process 600.

Nanowires 702 are polymer nanowires that are electro-spun and aligned on the grounded collector 704.

A representative process for forming nanowires 702 begins with loading a syringe with a solution containing 14 wt % of polyvinylpyrrolidone (PVP, M.W.=1.3×106 g/mol, Acros) and anhydrous ethanol (Sigma-Aldrich, 99.5%). The needle tip of the syringe is then electrically connected to a voltage supply that provides a +4 kV potential to the needle tip, referenced to collector 704.

Collector 704 is a grounded metal piece having an electric field applied across its two edges. The electric field aligns the electro-spun polymer nanowires across gap. In some embodiments, the two parallel edges are approximately one inch apart, although this spacing can be varied as necessary.

The distance between the syringe needle tip and the grounded collector is controlled (e.g., as 15 cm), and the polymer solution is ejected at an exemplary pump rate of approximately 0.15 ml/h to form a droplet at the needle tip.

The high electrical potential and surface charges pull polymer nanowires out of the droplet in front of the needle. The polymer nanowires are attracted toward collector 704, thereby forming free-standing nanowires that lay across the two edges of the collector. Nanowire density and spacing is controlled by controlling electro-spinning time.

It should be noted that electro-spinning enables production of polymer wires having diameters within the range of less than one hundred nanometers to a few microns. It has been also used in the prior art to produce wires of a variety of inorganic materials. It is another aspect of the present invention that prior-art electro-spinning techniques can be extended to make mesoscale wires having larger diameters.

At operation 602, copper is evaporated onto the polymer nanowires via thermal evaporation to realize copper mesoscale wires 706 having a thickness of up to 1 micron. In some embodiments, another suitable metal deposition process (e.g., e-beam evaporation, thermal evaporation, sputtering, etc.) is used to form copper mesoscale wires 706. It should be noted that forming mesoscale wires via the combination of electro-spinning and metal deposition offers a relatively inexpensive alternative to a conventional photolithography process.

At operation 603, the free-standing copper mesoscale wires 706 are transferred onto silver nanowire transparent electrode 708. Silver nanowire transparent electrode 708 is analogous to prior-art silver nanowire structures, such as those disclosed by Tao, et al., in “Langmuir-Blodgett Silver Nanowire Monolayers for Molecular Sensing Using Surface-enhanced Raman Spectroscopy,” Nano Letters, Vol. 3, pp. 1229-1233 (2003). A representative process for forming electrode 708 includes:
i. heating a mixture of 0.334 g PVP and 20 mL of ethylene glycol (Sigma-Aldrich) to 170° C. in a three-neck glass flask;
ii. adding 0.025 g of finely ground silver chloride to the flask to initiate nucleation of silver seeds;
iii. titrating 0.110 g of silver nitrate for 10 min;
iv. reacting the mixture by heating it for 30 min to complete the reaction;
v. cooling the solution and centrifuging it at 6000 rmp for 30 min;
vi. redispersing the precipitates of AgNWs in 30 mL of methanol; and
vii. spin-coating the dispersion onto a suitable substrate.

The transmittance and sheet resistance of silver electrode 708 is controlled by controlling the concentrations of the constituent chemicals, spin-coating speed, and spin-coating time.

In some embodiments, in order to transfer the mesoscale wires, alcohol is applied to silver electrode 708 to dissolve its polymer core away. This also generates capillary force that pulls the copper mesoscale wires towards the substrate as the solvent evaporates. In some embodiments, a calender machine is employed to improve the physical contact between the copper mesoscale wires and the transparent electrode.

At operation 604, the copper mesoscale wires and silver nanowire electrode are roll pressed and annealed in argon to fuse the nanowire-nanowire junctions and nanowire-mesoscale wire junctions. This facilitates creating a continuous conducting pathway and completes the formation of wire network 710.

At optional operation 605, a layer of suitable material is formed on TCE 100 to substantially planarize the surface of the electrode.

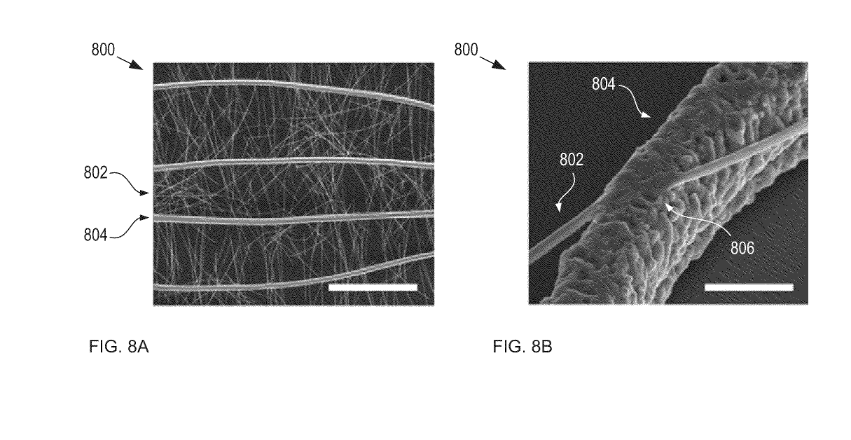

FIG. 8A depicts a scanning electron microscope picture of a portion of a transparent conductive electrode in accordance with the first alternative embodiment of the present invention. TCE 800 includes nanowires 802 and mesoscale wires 804, which are arranged in the aligned configuration shown. It should be noted the wire network of TCE 800 was formed using a sacrificial polymer film that was used for the subsequent lift-off of the wire network to enable characterization of the morphology from the back side.

FIG. 8B depicts a scanning electron microscope picture of a fused junction between a nanowire 802 and a mesoscale wire 804. As can be seen the photo, mesoscale wire 804 and intersecting nanowire 802 are fused into each other to form fused junction 806. This guarantees low contact resistance between the nanoscale layer and the mesoscale layer. The electro-spun free-standing mesoscale wires 804 can also be applied to other types of transparent electrodes. This versatility makes the mesoscale concept of the present invention applicable to different types of optoelectronic devices with special requirements for transparent electrodes, e.g. conduction/valence band position, buffer layer, and so on.

It is another aspect of the present invention that a mesoscale metal-wire composition can be incorporated into a first layer comprising other than nanowires, such as a traditional TCE composition or another film comprising a suitably electrically conductive material, to improve its R_{S}-T performance. Materials suitable for use in such a first layer include, without limitation carbon nanotubes, ITO, AZO, Polystyrene Sulfonate (PEDOT:PSS), SnOx, conducting polymers, TiO2, ZnO, and the like.

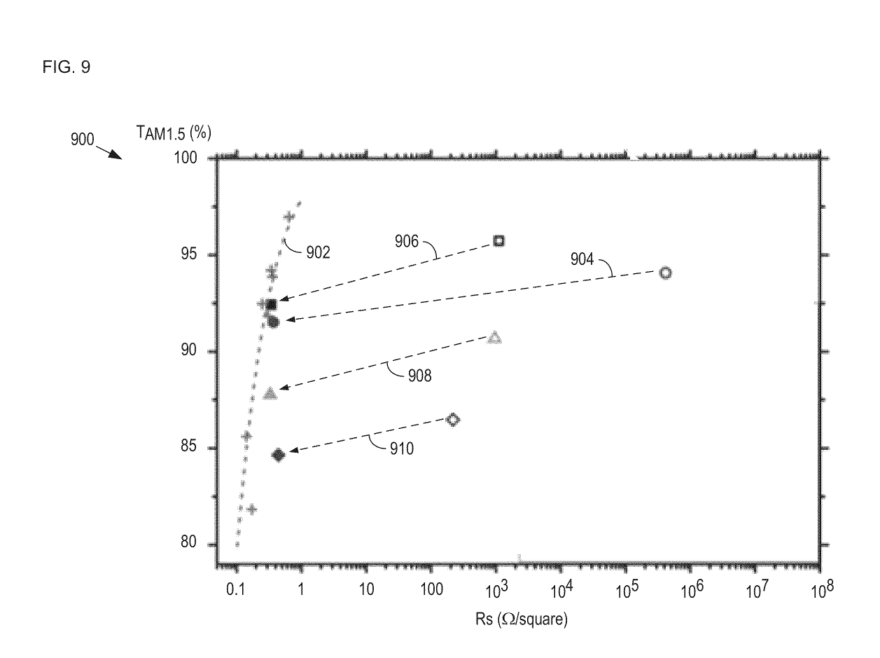

FIG. 9 depicts measured performance results for copper mesoscale wires transferred onto different material networks. Plot 900 shows the R_{S}-T performances for copper mesoscale wires transferred onto a silver nanowire network, as well as different TCE compositions based on ITO, AZO, PEDOT:PSS, and bare glass substrates.

Plot 900 demonstrates significant effectiveness of copper mesoscale wires in improving the R_{S}-T performances of each of the different transparent electrodes.

Trace 902 shows that a composition of only copper mesoscale wires can have sheet resistance and transmittance within the range of (0.15 Ω/□, 85%) to (0.64 Ω/□, 97%). The specific values of R_{S}-T performance within this range depends upon wire density, which is controlled by electro-spinning time.

Lines 904, 906, 908, and 910 show the improvement in R_{S}-T performance achieved by incorporation of copper mesoscale wires in conventional TCEs comprising PEDOT:PSS, gold nanowires, AZO, and ITO, respectively. Plot 900 shows that, after incorporating copper mesoscale wires into each conventional TCE composition, the sheet resistance of each sample was improved to below 0.4 Ω/□ with less than 3% change in transmittance. Based on the shift of (R_{S}, T) value, the average (R_{S}, T) of electro-spun copper mesoscale wires can be calculated to be (0.40±0.05 Ω/□, 97.1±0.6%).

It should be noted that the underlying conventional TCE material and the copper mesoscale wires are in parallel configuration. As a result, with the addition of copper mesoscale wires into each TCE composition, the sheet resistance of the combined composition shifts closer to the values of copper mesoscale wires, while its transmittance is approximately the product of that of the conventional TCE material and copper mesoscale wires.

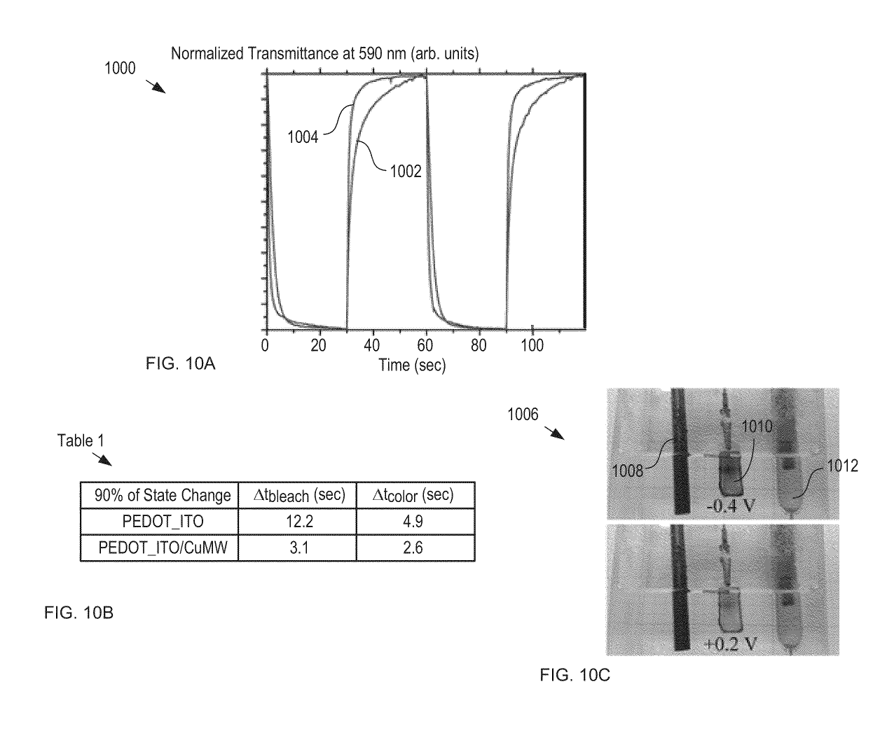

FIG. 10A depicts the coloration response versus time for PEDOT:PSS-based electrochromic devices, with and without, incorporated mesoscale wires. Plot 1000 shows the normalized transmittance for two electrode compositions over a time period of 120 seconds, wherein the potential of PEDOT is switched between +0.2 V (bleached) and −0.4 (color) versus Ag/AgCl every 30 seconds. For PEDOT, the color is light blue when at +0.2 V and dark blue when at −0.4 V. Trace 1002 shows the transmittance for TCE_Composition1, which comprises PEDOT and ITO. Trace 1004 shows the transmittance for TCE_Composition2, which is in accordance with the present invention. TCE_Composition2 is substantially identical to TCE_Composition1; however, TCE_Composition2 also includes copper mesoscale wires.

It can be seen that, for each of TCE_Composition1 and TCE_Composition2, color-state transitions lag voltage-potential changes. This is due to the kinetics of doping and undoping processes inside the electrochromic material. It is clear from plot 1000, however, that the addition of copper mesoscale wires to TCE_Composition1 significantly reduces the time required for the transparent electrode to change color.

FIG. 10B provides Table 1, which includes measured bleaching and coloring response times for TCE_Composition1 and TCE_Composition2. With respect to color bleaching, for example, the switching time t (Δt_{bleach}) to reach 90% of color-state change for TCE_Composition1 is 12.2 seconds, but TCE_Composition2 requires only 3.1 second. This represents an approximately 4× improvement in response time. The improvement is due, in part, to the fact that TCE_Composition2 has a lower sheet resistance. As a result, its resultant reduced ohmic resistance gives rise to an increase in electric current, even though the voltage potential steps are the same. This enables the coloration and bleaching processes to proceed faster with TCE_Composition2 as compared to TCE_Composition1

Moreover, a lower sheet resistance results in reduced power dissipation and improved energy efficiency. In many applications, such as TCEs for large-area smart windows, the improved color-switching time and lower power dissipation afford embodiments of the present invention significant advantages over prior-art TCEs.

FIG. 10C depicts a photograph of a TCE comprising copper mesoscale wires in its color state and bleached state. Photo 1006 shows graphite counter electrode 1008, PEDOT:PSS electrochromic thin film 1010, and Ag/AgCl reference electrode 1012. The electrolyte is 1M LiClO₄ in acetonitrile and the size of the electrochromic sample is approximately 1 cm×2.54 cm.

From the simulations and experiments described above, it is evident that the addition of mesoscale metal wire to a nanowire TCE, in accordance with the present invention, can decrease the sheet resistance of a TCE by orders of magnitude without significant negative impact on its optical transmittance. It should be also be noted that the mesoscale-wire concept disclosed herein can be applied to other types of TCEs with similar positive impact.

It is to be understood that the disclosure teaches just one example of the illustrative embodiment and that many variations of the invention can easily be devised by those skilled in the art after reading this disclosure and that the scope of the present invention is to be determined by the following claims.

1. A TCE composition comprising:
a background medium that includes a first material that is electrically conductive; and
a plurality of mesoscale wires, each mesoscale wire of the plurality thereof comprising a second material that is electrically conductive;
wherein the background medium and the plurality of mesoscale wires are electrically connected, and wherein the TCE composition has a sheet resistance that is less than or equal to 1 ohm/square and a transmittance for an optical signal that is equal to or greater than 75%.

2. The TCE composition of claim 1, wherein the first material is selected from the group consisting of metals, oxides, nitrides, polymers, carbon nanotubes, graphene, silicides, graphene nanoribbons, and oxide nanowires.

3. The composition of claim 1, wherein at least one mesoscale wire of the plurality thereof mesoscale wires has a width that is within the range of approximately 1 microns to approximately 5 microns, and wherein the mesoscale wires of the plurality thereof are arranged with an inter-wire spacing that is within the range of approximately 50 microns to approximately 500 microns.

4. The composition of claim 1, wherein at least one mesoscale wire of the plurality thereof mesoscale wires has a width that is within the range of approximately 4 microns to approximately 6 microns, and wherein the mesoscale wires of the plurality thereof are arranged with an inter-wire spacing that is within the range of approximately 300 microns to approximately 500 microns.

5. The TCE composition of claim 1, wherein the background medium comprises a plurality of nanowires.

6. The composition of claim 5, wherein at least one nanowire of the plurality thereof has a width that is within the range of approximately 1 nm to approximately 300 nm, and wherein the nanowires of the plurality thereof are arranged with an inter-wire spacing that is within the range of approximately 3 microns to approximately 30 microns.

7. The composition of claim 5, wherein at least one nanowire of the plurality thereof has a width that is less than or equal to 100 nm, and wherein the nanowires of the plurality thereof are arranged with an inter-wire spacing that is within the range of approximately 3 microns to approximately 10 microns.

8. The composition of claim 5, wherein the nanowires of the plurality thereof are substantially parallel, and wherein the mesoscale wires of the plurality thereof are substantially parallel, and further wherein each of the plurality of nanowires is substantially orthogonal with each of the plurality of mesoscale wires.

9. The composition of claim 5, wherein each of the plurality of nanowires comprises a metal.

10. The composition of claim 5, wherein the first material is a polymer.

11. The composition of claim 1, wherein the second material is a metal.

12. The composition of claim 1, wherein the composition has a transmittance for an optical signal that is equal to or greater than 90%

13. A TCE composition comprising:
a plurality of nanowires, each nanowire of the plurality thereof including a first material that is electrically conductive; and
a plurality of mesoscale wires, each mesoscale wire of the plurality thereof comprising a second material that is electrically conductive;
wherein the plurality of nanowires and the plurality of mesoscale wires are electrically connected such that they collectively have a sheet resistance that is less than or equal to 1 ohm/square and a transmittance for an optical signal that is equal to or greater than 90%.

14. The composition of claim 13, wherein the mesoscale wires of the plurality thereof have (1) a width that is within the range of approximately 4 microns to approximately 6 microns and (2) are arranged with an inter-wire spacing that is within the range of approximately 300 microns to approximately 500 microns.

15. The composition of claim 14, wherein at least one nanowire of the plurality thereof has a width that is less than or equal to 100 nm, and wherein the nanowires of the plurality thereof are arranged with an inter-wire spacing that is within the range of approximately 3 microns to approximately 10 microns.

16. The composition of claim 13, wherein the nanowires of the plurality thereof are substantially parallel and lie along a first direction, and wherein the mesoscale wires of the plurality thereof are substantially parallel and lie along a second direction that is substantially orthogonal with the first direction.

17. A method for forming a TCE composition, the method comprising:
forming a background medium having a first sheet resistance and a first transmittance for an optical signal, the background medium including a first material; and
incorporating a plurality of mesoscale wires with the background medium such that the background medium and the plurality of mesoscale wires are electrically connected, wherein the mesoscale wires of the plurality thereof comprise a second material, and wherein the plurality of mesoscale wires and the background medium collectively define a first composition;
wherein the first composition is characterized by (1) a second sheet resistance that is lower than the first sheet resistance and (2) a second transmittance for the optical signal, the second transmittance being greater than or equal to 80% of the first transmittance.

18. The method of claim 17 further comprising providing the plurality of mesoscale wires such that at least one mesoscale wire of the plurality thereof has a width that is within the range of approximately 1 microns to approximately 5 microns and the mesoscale wires of the plurality thereof are arranged with an inter-wire spacing that is within the range of approximately 50 microns to approximately 500 microns.

19. The method of claim 17 further comprising providing the background medium as a plurality of nanoscale wires including at least one nanoscale wire having a width that is within the range of approximately 1 nm to approximately 300 nm, wherein the nanoscale wires of the plurality thereof are arranged with an inter-wire spacing that is within the range of approximately 3 microns to approximately 30 microns.

20. The method of claim 17 further comprising providing the mesoscale wires by operations comprising:
electro-spinning a plurality of polymer nanowires;
aligning the polymer nanowires on an electrode; and
depositing the second material on the polymer nanowires.
